(19) United States
(12) Patent Application Publication
(10) Pub. No.: US 2006/0238357 A1
(43) Pub. Date: Oct. 26, 2006

(54) Man-portable and autonomous emitting device, in particular for a man in sea

(76) Inventor: Michel Gautier, Le Haillan (FR)

Correspondence Address: YOUNG & THOMPSON, 745 SOUTH 23RD STREET, 2ND FLOOR, ARLINGTON, VA, 22202, US

(21) Appl. No.: 10/546,818

(22) PCT Filed: Feb. 27, 2004
(86) PCT No.: PCT/FR04/50087

§ 371 Date: May 26, 2006

(30) Foreign Application Priority Data
Feb. 28, 2003 (FR) 03/02446

(51) Int. Cl. G08B 23/00; G08B 21/08

(52) U.S. Cl. 340/573.1; 340/573.6

(57) ABSTRACT

A man-portable and autonomous signal-emitting device, in particular for a man in sea includes a container (10) provided with elements (12) for fixing to a carrier, an insert (14) provided with at least one function for the power supply thereof (16), elements (18) for actuating the insert and removable mechanical members (20) for initiating the actuating elements (18).

The present invention relates to a portable and self - contained device for emitting a signal, particularly for a man overboard.

Such a device is to be triggered voluntarily and/or automatically, by mechanical action.

There are known numerous devices which are secured to clothing worn by a sailor or any other person exposed to the risk of falling overboard.

So as to give precise examples, the case in question is that of a professional or amateur sailor, but the similar applications which would require the same devices are comprised within the present invention.

Thus, U.S. Pat. No. 4,714,914 discloses an alarm device for a man overboard.

More particularly, such a device comprises an emitter carried by each individual onboard a navigable structure. This emitter comprises a self-contained energy source such as a battery and a contact with separated electrodes adapted to be activated by immersion of these two electrodes in a conductive medium such as saltwater.

On board the navigable structure, there is provided a receiver of the signals emitted by the emitter when the electrodes are immersed.

The problem with this type of device is to be able to protect the electrodes so as to avoid false alarms due to temporarily placing them in contact by penetration of water for example during a projection of seawater by a wave, whilst maintaining reliably its service condition of case of real immersion synonymous with falling overboard.

In this case, there is provided a timer, but this is sensitive and any timing involves a delay of the alarm in the case of a real fall, which is always undesirable.

Other systems operate with a portable emitter and a receiver integrated with the navigable structure. Continuously, with a frequency of the order of several seconds, the emitter interrogates by a very brief signal the receiver so as to obtain a response. As soon as the emitter and the receiver are spaced apart by a distance greater than the programmed distance, there is a triggering of emergency devices.

Such a receiver is for example integrated in the hull of the boat about its periphery. It is thus difficult to move away from it more than several meters. If the emitter signal is not received, it is because there is too great a distance and hence a man overboard situation.

Such systems are interesting in the sense that they can be permanently monitored that they are in operation. On the other hand, they remain fragile and the emitters must be continuously supplied, which leads to a high consumption even if this emission requires a very small quantity of energy.

Moreover, the problem is complicated when there are several persons onboard because there must be one frequency per person and it is necessary to manage all of the sources of energy.

Finally, another constraint is returning to land for fishermen for example because they do not think to deactivate the system before debarking, and there is produced an involuntary triggering and replacing and service of security measures which must then be returned and reset. This is not satisfactory.

These electrical or electronic systems also have the drawback of not being able to be triggered voluntarily by one of the crew of the navigable structure remaining onboard the boat, who sees another team member fall overboard.

In such systems, there should be a switch which can be rapidly and easily accessed but not in an untimely manner.

It must be remembered that the conditions under which such accidents take place are often difficult, and the cold, the seawater, encumbrance with oilskins, vests, gloves, do not make movement very easy particularly to reach a small switch protected from shocks.

Numerous known devices are theoretically satisfactory but remain difficult to use under conditions in which they become necessary. It is also known from French patent FR 2 638 705 a device with an emitter and a receiver operating in water; because there is thus needed an assembly of emitter/receiver which operates either in air or in water. In the case in which it operates in air, the antenna and the emitter carried by the victim must be out of the water and in the case in which it operates in water, the emitter must be immersed and it is necessary to provide the boat with a detector that is similarly immersed. It is this mounting which is described in the prior art application.

U.S. Pat. No. 5,520,486 also discloses a device comprising a closed chamber which contains an internal core provided with means for triggering and extracting this core. With this core is associated, in addition to known signaling means, an inflatable element permitting the core to rise to the surface if this is device is essentially used for the help of divers in difficulty.

Such a device is of limited accessibility and delicate to manipulate and if it can be conceived of in theory, it appears very delicate to put into use under conditions of panic and particularly in the case of heavy seas, as is usually the case.

U.S. Pat. No. 4,079,364 is also known in the field of lifesaving signals and provides a signal adapted to be carried by a user, but this signal is for automatic release by Archimedes pressure or by known means such as rapidly dissolving tablets.

This signal is a type that emits distress signals such as a horn or smoke.

This patent relates to triggering means without connection with the navigable structure and even less manual triggering.

The object of the present invention is to provide a device for persons onboard a navigable structure, which overcomes the drawbacks of the prior art, which can be triggered manually and/or automatically, which is simple and does not require any continuous supply, which can be triggered even when the individual is fully clothed, which is completely reliable, which is not connected to the, number of passengers and which can thus be multiplied without complicating the installation.

The device according to the present invention will now be described in detail in terms of a preferred embodiment and modifications, this description being carried out with respect to the accompanying drawings, in which the different figures represent:

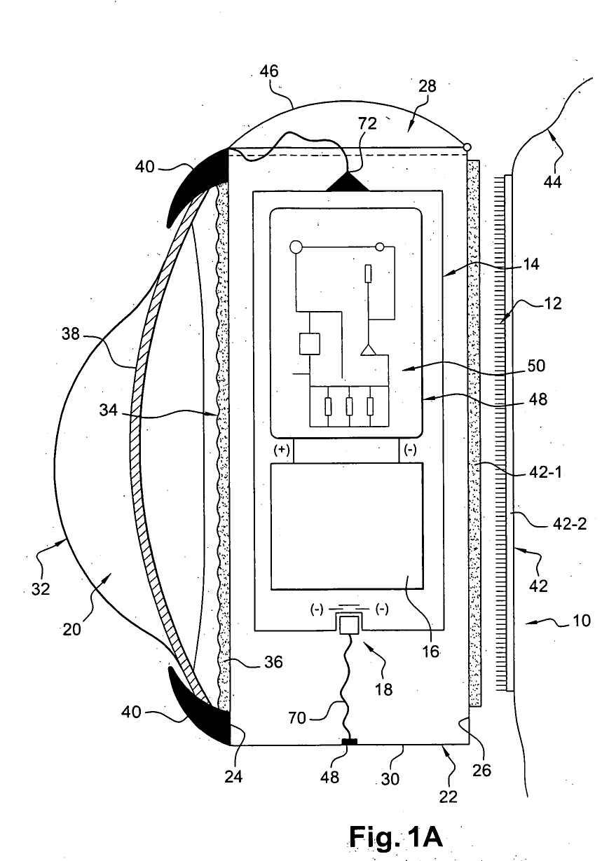

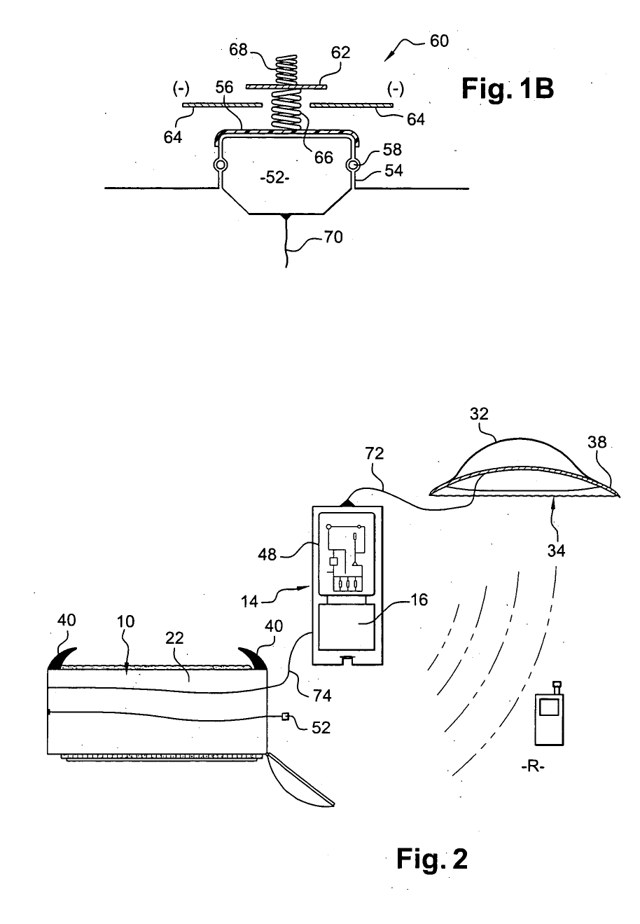

FIG. 1A, a schematic view of the preferred embodiment of the device according to the present invention, simplified, with omission of the emitter,

FIG. 1B, a detailed view of an example of sealed contactor,

FIG. 2, a schematic view of the device in the course of installation,

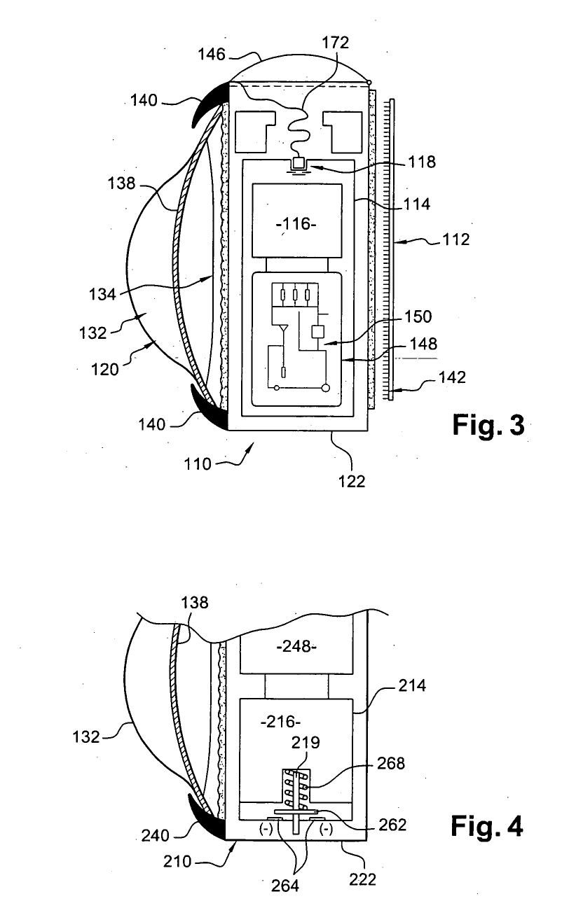

FIG. 3, a schematic view of a first modification of the device according to the invention, without removal of the emitter,

FIG. 4, a schematic view of a modified embodiment of the switch,

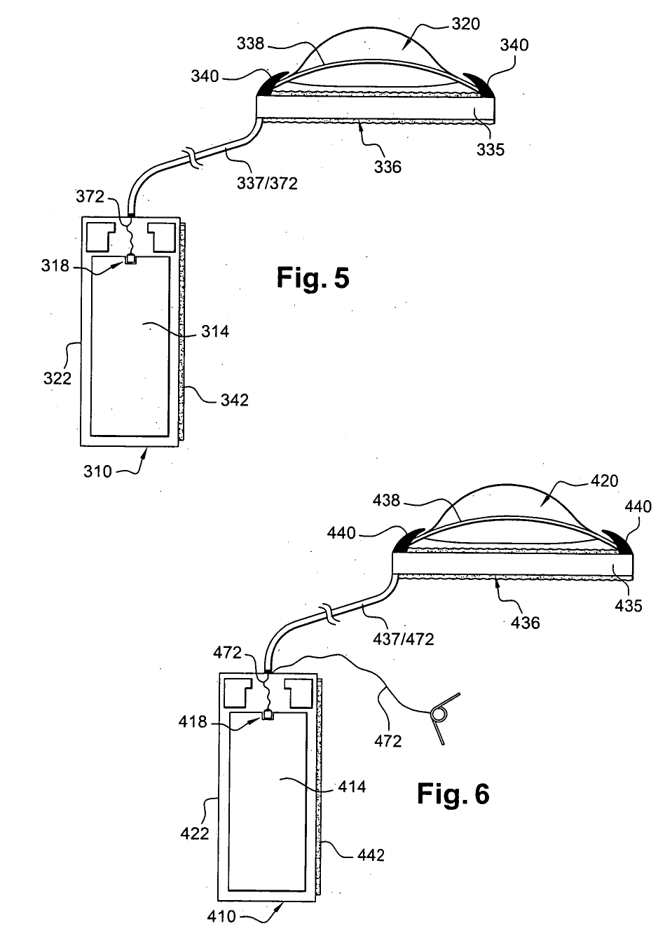

FIG. 5, a schematic view of a second embodiment of the device with a sheathed cable,

FIG. 6, an improvement of the second modification,

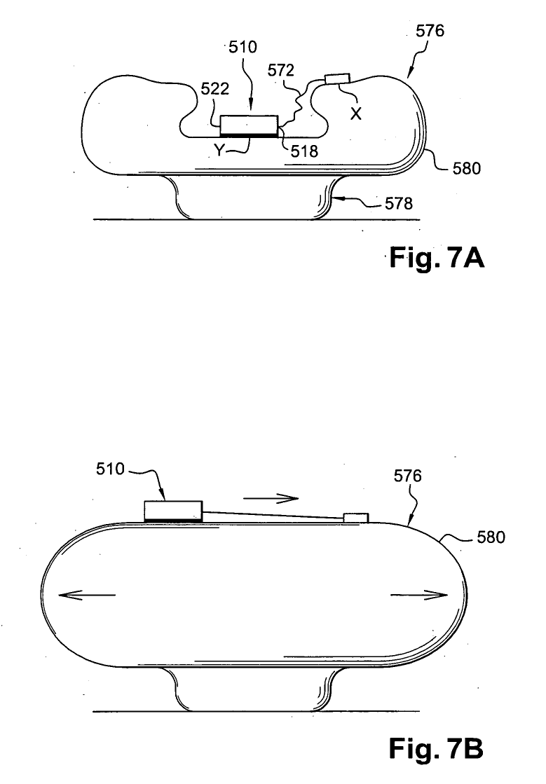

FIGS. 7A and 7B, a schematic view of a third embodiment of the device with an inflatable ladder, in the phases before and after inflation,

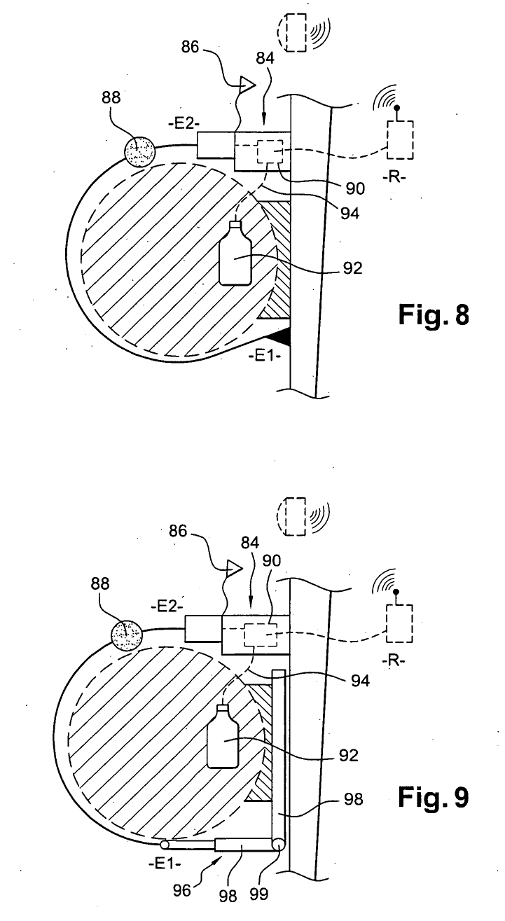

FIG. 8, a view of a first embodiment of launching a lifeboat, and

FIG. 9, a view of a second improved embodiment of launching a lifeboat.

In FIG. 1A, there is shown a receptacle 10 with securement means 12, an insert 14 with at least one function with its electrical supply 16, means 18 for placing in service this insert and removable mechanical means 20 for triggering these means 18 for placing in service.

The receptacle 10 is for example a housing 22 of plastic material comprising an upper surface 24 and a lower surface 26 as well as two right and left surfaces 28 and 30, respectively.

The upper surface 24 carries a handle 32 of the ergonometric type and easily grasped by one hand, even when gloved. Removal connecting means 34 of this handle are interposed between such handle and its upper surface. In the embodiment in question, there is a set 36 of self-gripping strips of the “Velcro” type, completed by a flexible blade 38 bent between two abutments 40.

The lower surface 26 carries procurement means 12 which comprise in this case a set of self-gripping strips 42 of the “Velcro” type with a strong gripping power, a portion 42-1 being connected to this lower surface 24 and another portion 42-2 being connected to a garment 44 adapted to be worn by the person to be protected.

As a modification, the securement means could be quite simply a belt.

The housing 22 is sealed and comprises a cover 46 positioned on the right surface 28, in the illustrated embodiment. This cover is sealed but removable with reasonable effort.

The housing moreover comprises on its left surface 30, on the interior an anchoring point 48.

The insert 14 with at least one function comprises an active member 48. In the present case of the device in its- basic embodiment, this active member permits only a single function, namely, a function of emitting a signal according to a given frequency adapted to act on a receiver R shown in FIG. 2.

The member 48 comprises an electronic circuit 50 which can be embedded in the resin to render it totally insensitive to the environmental medium.

This active member 48 is connected to the electrical supply means 16.

On the other hand, the means 18 for placing in operation are interposed between said member 48 and said electrical supply means so as to supply this member only upon triggering as will be explained ultimately. A schematic example of such means 18 for placing in service is shown in FIG. 1B.

There is a core 52 immobilized in a blind recess 54 of the insert 14, closed by a flexible membrane 56. This core is immobilized in this recess removably by any suitable means, in this case a circlip 58.

A switch 60 comprises a bridge 62 and two terminals 64, this bridge being secured to a spring 66 bearing on the core 52. Another spring 68, weaker than the spring 66, tends to press this bridge against the terminals.

Thus, the bridge can have two positions, one shown in FIG. 1B in which the bridge is separated from the terminal 64 of the switch, the spring 66 being predominant, and the other, not shown, in which the bridge is pressed against the terminals, the spring 66 being no longer effective, only the spring 68 acting and ensuring thus the electrical continuity.

A connection 70 constitutes the mechanical connection between the core 52 and the anchoring point 48.

Moreover, another connection 72 constitutes the connection between the insert 14 and the removable mechanical triggering means 20, more particularly with the handle 32 in the present case.

This connection can comprise a conductive cable, for example of copper alloy, adapted to propagate the signal emitted by the active member 48.

The device according to the present invention will now be described in its embodiment more particularly shown in FIG. 2.

This embodiment relates to a person provided with a sailboat for pleasure or professional fishing.

All the crew are provided with protective clothing against cold, watch jackets, or against water, fishermen's slickers. Each item of clothing comprises a portion 42-2 of the securement means connected to this clothing, for example by stitching.

Moreover, a receiver of the signal emitted by the active member is provided on the boat and is continuously in service, ready to receive, connected to the onboard supply.

There can be provided as receiver of this signal, a radio receiver adapted to detect a given frequency, corresponding only to that of the active member 48 of each of the crew members, this frequency being the same for all the active members.

When the crew members work or maneuver, the member 48 remains unsupplied, and each emission will consume a portion of the reserve of electrical supply 16. The system is not on standby, always stopped, except the receiver, but it does not itself give rise to any problem of consumption.

If someone falls overboard, he grasps as soon as possible the handle 32 of an ergonometric type and easily seizable, even with gloves and in the water, under a condition of stress. The reflex is rapid and the gripping of this lifesaving handle is almost instantaneous.

By pulling on this handle, the flexible blade 38 bends a little more and permits the extraction from the abutments 40.

The removable connection means 34 for this handle have a limited retention force, easily overcome during pulling on the handle, above all under conditions of stress when the force is multiplied.

The person overboard pulls on the handle which, by connection 72, ensures the extraction of the insert 14 from the sealed receptacle 10.

This insert is extracted to the right side and the cover, closed or pivoting, is automatically withdrawn by traction.

Upon movement of this insert outside the receptacle, the connection 70 which is anchored to the bottom of the housing 22 of which the receptacle 10 is constituted, ensures the freeing of the means 18 for placing this insert in service.

When the preferred embodiment shown in FIG. 1B is used, the core 52 is extracted from the recess 54, by springing the circlip 58. The spring 66 not longer bears against and deforms the sealed membrane 56. The spring 66 places the bridge 62 against the contact 64, supplying the electronic circuit 50 of the insert.

When this circuit 50 is supplied, it instantaneously emits a signal detected by the receiver R located onboard.

The handle remaining in the hand of the man overboard, serves as an antenna because of its metallic portion, the blade 38, the connection 72 being adapted to complete this emitting portion.

The persons in question are conscious and are able to stay on the surface either by swimming or because of a floating lifesaving device such as a vest or garment.

Preferably, a line 74, secured to the receptacle, avoids loss of the insert, even the case of releasing the handle.

The emitted signal can be processed and can act from the receiver on any other element. Thus the signal can trigger a visual or sonic alert onboard the boat or can ensure a release of lifesaving means such as life raft as will be described hereafter, a rotating buoy, visualization means, to cite only a few.

Similarly, the described insert comprises a single function, but it is altogether possible to provide several functions and even a telecontrol with controls of the principal functions of the boat:
the tiller to bring the sailboat around,
motor power so as to stop the boat,
the rudder of a motorboat can cause it to circle.

Similarly, all the variants of securement can be modified and the sets of strips can be replaced by flexible magnetic sheets.

The housing 22 of the receptacle can have any suitable shape for better location on the wearer with the objective always of limiting the encumberment and hindrance of movement of the wearer.

There can also be provided, as in FIG. 3, a variant, reference numerals of identical items being increased by 100.

Thus the insert 114 comprises a supply portion 116 and an active member 148 which remain in the housing 22 of the receptacle. The means 18 for placing in service are thus secured directly to the connection 172.

In this case, the connection 172 serves as an emission antenna, located outside the water when the handle is raised by a man overboard.

In FIG. 4, identical elements bear the same reference numerals as in FIGS. 1A and 1B, increased by 200.

The modification is located in the means 218 for placing in service.

In this case, there is a bridge carried by a rod 219 slidable through the wall of the insert 214. A spring 268 ensures pressing the bridge 262 against the terminals 264. This rod is blocked on the bottom of the housing 222 of the receptacle 210. As soon as the insert 214 is withdrawn, the rod, having no more bearing, gives under the force of the spring and will press the bridge against the terminals, ensuring the supply of the circuit 250.

In FIG. 5, identical references bear the same reference numerals as in FIG. 1A and 1B, increased by 300.

In this modification, it is of interest to have removable mechanical means 320 for triggering the means 318 for placing in service which are removed.

Receptacle 310 has its own securement means 312, its insert 314 with at least one function with its electrical supply 316, and means 318 for placing in service this insert.

A sleeve 337 is interposed between a base 335 secured to the clothing by means 336 and the housing 322 containing the insert so as to be able to ensure the starting of the means 318 for placing this insert in service.

In the case in which there is provided an extraction of the insert, reference is had to FIG. 6 on which the reference numerals are the same as those in FIG. 5 but with an increase of 100.

The extraction connection 472 of the insert 414 is prolonged and fixed on the insert to be able to be gripped after placing in service said insert. This prolongation is free from a sleeve.

This prolongation can also be associated with automatic triggering means.

Referring to FIGS. 7A and 7B, the references are the same as those of FIGS. 1A and 2, increased by 500.

These automatic means 576 as shown comprise a vest 578 which comprises at least one bladder 580 which is in the deflated condition when it is not used. Thus, the wearer is not hindered in his activities. This bladder comprises at least one portion in line with the neck, behind the head, forming a collar so as to maintain the body vertical, the head outside the water and the face turned toward the sky.

This type of personal lifesaving device is well known and in use at present.

This bladder is associated with a reservoir of air under pressure, generally a small bottle with a piercer, as well as a detector of placing in service.

Such a detector is sensitive to immersion and can be provided with electrodes and an electrical system but also more simply with a blocking tablet which dissolves when it is immersed. Because of this, it very rapidly frees a spring which pierces the bottle, ensuring the freeing of the gas and the inflation of the bladder, this even if the person is unconscious.

The assembly is generally duplicated by manual voluntary triggering means when the wearer is conscious.

The device according to the invention is combined with this type of lifesaving device with an inflatable bladder for its triggering.

Thus, the housing 522 of the receptacle 510 is connected at a point X of the bladder whilst the free end of the extraction connector 572 is fixed at another point Y on this same bladder or on the garment.

The points X and Y are spaced apart by a length less than the length of the connection 572 when the bladder is deflated and folded and by a length greater than the length of the connector 572 when the bladder is inflated, thus ensuring mechanical traction which triggers the means 518 for placing in service.

When the wearer falls in the water, the bladder inflates and ensures a traction on the connection 572 which places in service the electronic circuit 550.

Because the assembly is preferably disposed in the collar of the lifejacket, the antenna formed by the connection and/or the housing itself with its circuit will be located in a portion in the air to permit emission under good conditions toward the receiver R of the boat.

The device described with the handle and mechanical action can also be triggered by a crew member on the boat, when he detects the fall of another crew member even if this latter is also provided with a device. Thus, the saving of time can be appreciable and can assist in lifesaving under improved conditions. There is no collision of the actions but on the contrary a reinforcement.

It will be seen that the device according to the invention consumes no energy because it is free from a standby or exchange system when it is not in service. The mechanical traction means are of high reliability and can be manipulated under difficult conditions of falling into the water with the associated stress, at a cold temperature, even if the wearer has on gloves, and moreover, can be automated. In this case, as indicated, the manipulation can be manual as in the modification described, but also automatic in association with an inflatable bladder itself provided with certified triggering means.

Thus, the means are not uselessly multiplied to the detriment of reliability, which must be total in this type of safety equipment.

In FIG. 8, there is seen a first embodiment of a device for freeing rescue means such as a life raft.

In this figure, there is shown at 80 the stern of a boat, with a rescue kit 82 such as a container including an inflatable raft.

The survival kit is secured by straps of which one end E1 is fixed and whose other end E2 is connected to a central trigger 84.

This central trigger comprises several triggers:
a manual trigger 86, with mechanical locking,
a hydrostatic trigger 88, for example a salt tablet in the case of immersion of the boat by capsizing or in the case of shipwreck, and
an automatic trigger 90 connected to the receiver R on the boat receiving the signals from the insert of the emitter.

In known manner, the survival kit comprises a cartridge 92 and a rope 94 permitting its placing in service and with release of the compressed gas. The rope is connected to the cartridge on the one hand and to the automatic trigger 90 on the other hand. According to an improvement, it is possible to provide, as shown in FIG. 9, a cradle 96 with two arms 98 at 90° which receives the lifesaving kit. This cradle is articulated in its angle about an axle 99 so as to permit its pivoting.

In a still more sophisticated way, the arms can be of the telescoping type so as to facilitate adaptation to lifesaving kits.

It will be seen that the lifesaving kit can be released in the case in which the boat is in normal navigation, in the case in which the boat sinks and in the case in which the boat capsizes.

Thus, the rope 94 permits triggering inflation but moreover permits connecting the lifesaving kit to the boat when triggering is manual or hydrostatic.

The resistance of the rope is always less than the force of the buoyancy of the lifesaving kit, so as to release the kit if the boat sinks.

In the case of the use of an automatic trigger, the rope is released at the same time as the kit so as to avoid inflation. Only a shipwreck, once taking place in the immediate proximity, could trigger inflation. In the case of automatic inflation upon release, the risks of drifting away, particularly due to wind, would be too great.

It should also be noted, as a supplement to the description which has been given, that the active member 48 emits a signal over a common frequency which is detected by the receiver onboard the boat, but also for any other boat nearby and provided with the device according to the invention.

On the other hand, this emitter also emits coded information which can be received and interpreted only by the receiver R onboard the boat from which the victim has fallen, for example.

Thus, the victim can trigger actions onboard his own boat without disturbing neighboring boats, within the radius of the scope of the emitter.

1.Portable and autonomous device for emission of a signal, particularly for a man overboard, comprising a receptacle (1) with means (12) for securing on the wearer, an insert (14) with at least one function provided with its electrical supply (16), means (18) for placing in service this insert and removable mechanical means (20) for triggering these means (18) for placing in service.

2. Portable and autonomous device for emission of a signal according to claim 1, characterized in that the removable mechanical means for triggering comprise a handle (32) of ergonometric type and easily grippable by the hand, even when gloved, and removable connection means (34) for this handle with a support.

3. Portable and autonomous device for emission of a signal according to claim 2, characterized in that the removable connection means (34) are interposed between said handle (32) and the receptacle (10).

4. Portable and autonomous device for emission of a signal according to claim 3, characterized in that the removable connection means (34) are interposed between the handle (32) and the wearer and in that it comprises means (337/372) for extending connection.

5. Portable and autonomous device for emission of a signal according to claim 1, characterized in that the insert (14) is secured ,to removable mechanical means (20) for triggering by a connection (72) and extractable, the mean (18) for placing in service this insert being interposed between this insert (14) and the receptacle (10).

6. Portable and autonomous device for emission of a signal according to claim 1, characterized in that the means (18) for placing in service this insert (14) are secured to the removable mechanical means (20) for triggering by a connection (72), the insert (14) being secured to the receptacle (10).

7. Portable and autonomous device for emission of a signal according to claim 1, characterized in that the mechanical triggering means (20) comprise an inflatable bladder (580) provided with its own automatic triggering means, a connection (572) being interposed between the receptacle (510), at a point X on the bladder and another point Y, the points X and Y being separated by a length less than the length of the connection (572) when the bladder is deflated and folded and a length greater than the length of the connection (572) when the bladder is inflated, so as to ensure mechanical traction which triggers the means (518) for placing in service.

8. Portable and autonomous device for emission of a signal according to any one of the preceding claims claim 1, characterized in that the insert (14) comprises an emitter adapted to emit a signal over a common frequency which is detected by the receiver R onboard the boat but also by any other adjacent boat and adapted to emit coded information received and interpreted solely by the receiver R onboard the boat of the shipwrecked person.
